(19) United States
(12) Patent Application Publication
(10) Pub. No.: US 2008/0164774 A1
(43) Pub. Date: Jul. 10, 2008

(54) Motor Structure with a Brake Device

(76) Inventor: Chih-Yu WANG, Taichung Industrial Park (TW)

Correspondence Address: Dr. BANGER SHIA, 102 Lindencrest Ct., Sugar Land, TX, 77479-5201, US

(21) Appl. No.: 11/621,146

(22) Filed: Jan. 9, 2007

(51) Int. Cl. H02K 7/102

(52) U.S. Cl. 310/77

(57) ABSTRACT

A motor structure with a brake device comprises a base, a stator, a rotor, and a brake device. A hollow passage surface is formed in a side of the rotor, at a lower end of the hollow passage surface is formed a connecting portion, the brake device is located at the lower end of the base and connected to the connecting portion, so that the brake device is connected directly to the rotor. Since the brake device is directly connected to the connecting portion of the rotor, the number of components of the present invention is considerably reduced, thus reducing the cost while improving the assembly convenience and improving the operation stability of the motor.

### BACKGROUND OF THE INVENTION

1. Field of the Invention

The present invention relates to a motor structure with a brake device, and more particularly to a connection structure design between a torque motor and the brake device.

2. Description of the Prior Art

Currently, rotating platforms are used in various equipments or mechanism, such as: wafer inspection equipment, automatic equipment, indexing plate, and all these equipments need a rotating platform. The rotating platform employs a torque motor as a rotating mechanism. And in order to meet the operation requirement, the torque motor is usually provided with a brake device which is employed to carry out deceleration and brake operation for the rotating platform.

With reference to FIG. 1, a conventional torque motor with brake device is provided with a rotor 10 and a stator 11 that are concentrically arranged. A brake device 12 is disposed at the lower end of the motor, and disposed on the upper end of the motor is a disc-like torque transferring connector 13 to be connected to the rotor 10. A connecting member 14 is inserted through a central passage 15 of the motor, and then both ends of the connecting member 14 are connected to the transferring connector 13 and the brake device 12, respectively.

The abovementioned torque uses the transferring connector and the connecting member as a connection structure for connecting the rotor and the brake device, therefore, the structure and the assembly mode must take into consideration the balance of structure and arrangement of the motor, so that the motor can operate stably and smoothly whenever in a normal operation state or in a brake operation state.

It is to be noted that the connection structure between the conventional torque motor and the brake device not only has many components but also is complicated in structure.

The present invention has arisen to mitigate and/or obviate the afore-described disadvantages.

### SUMMARY OF THE INVENTION

The primary objective of the present invention is to provide a motor structure with a brake device, wherein a hollow passage surface is formed in a side of the rotor, at a lower end of the hollow passage surface is formed a connecting portion, the brake device is located at the lower end of the base and connected to the connecting portion, so that the brake device is connected directly to the rotor. Since the brake device is directly connected to the connecting portion of the rotor, the number of components of the present invention is considerably reduced, thus reducing the cost while improving the assembly convenience and improving the operation stability of the motor.

### BRIEF DESCRIPTION OF THE DRAWINGS

FIG. 1 is a cross sectional view of showing a conventional torque motor; and

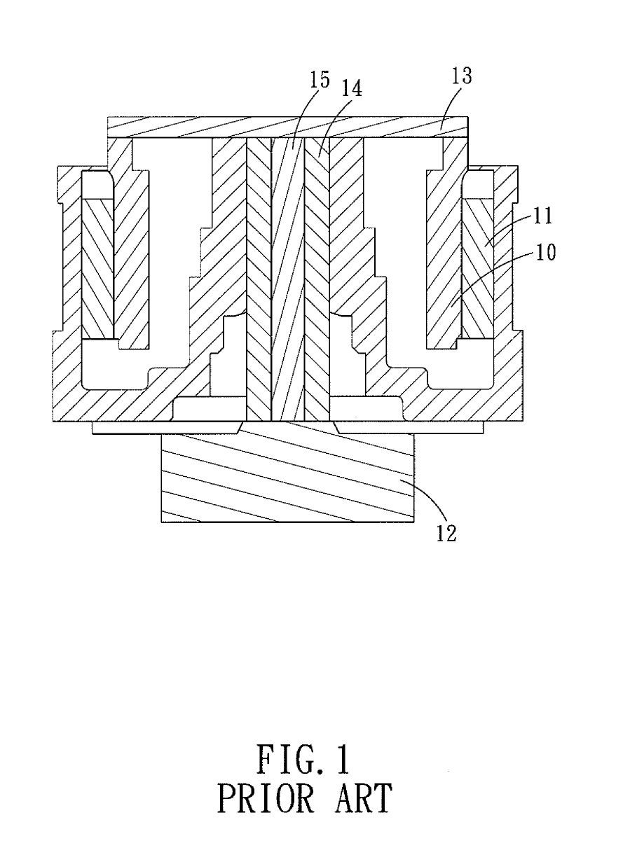

FIG. 2 is a cross sectional view of a torque motor in accordance with the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

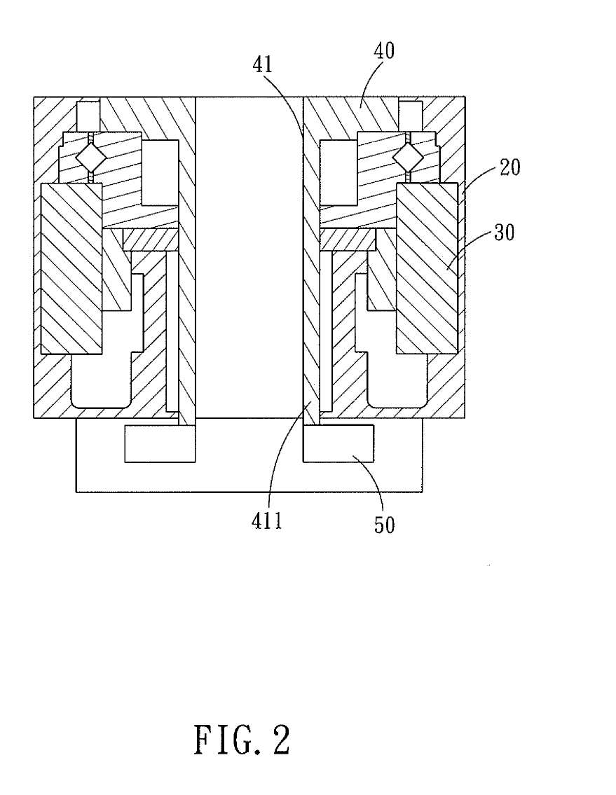

Referring to FIG. 2, a motor structure with a brake device in accordance with the present invention comprises: a base 20, a stator 30, a rotor 40, and a brake device 50.

The base 20 is a mounting frame on which the respective components of the motor are to be mounted.

The stator 30 is a hollow annular structure fixed in the base 20 and serves as a magnetic field generating structure for the motor.

The rotor 40 is rotatably disposed in the base 20 and is located inside the stator 30 and is rotatable relative to the stator 30. The rotor 40 is a magnetic field rotating member for the motor and is an annular hollow structure. In the inner surface of the rotor 40 is defined a hollow passage surface 41, and at the lower end of the hollow passage surface 41 is formed a connecting portion 411. The upper and lower ends of the hollow passage surface 41 are flush with the upper and lower ends of the base 20.

The brake device 50 serves to decelerate or stop the rotation of the motor and is disposed at the lower end of the base 20 and is connected to the connecting portion 411 of the rotor 40, such that the brake device 50 is directly connected to the rotor 40 so as to decelerate or stop the rotation speed of the motor.

The brake device 50 of the present invention can be directly connected to the rotor 40, therefore, not only the structure cost is reduced but also the assembly convenience is improved.

For a better understanding of the operation of the present invention, reference should be made to FIG. 2 again, the inner surface of the rotor 40 in accordance with the present invention is directly formed with a hollow passage surface 41, and at the lower end of the hollow passage surface 41 is formed a connecting portion 411. The brake device 50 can be disposed at the bottom of the base 20 and is directly connected to the connecting portion 411.

It is to be noted that since the brake device 50 is directly connected to the connecting portion 411 of the rotor 40, unlike the conventional motor that must cooperate with extra transferring member and connecting member to connect the rotor with the brake device. Therefore, the number of components of the present invention is considerably reduced, thus reducing the cost while improving the assembly convenience and improving the operation stability of the motor.

In addition, the inner surface of the rotor 40 in accordance with the present invention is directly formed with a hollow passage surface 41 that is compatible with the hollow structure design of the motor, and the hollow passage is provided for accommodation of wires.

It is to be noted that since the brake device 50 is directly connected to the motor rotor 40, since the number of components of the connecting structure is relatively small, the assembly error between the components is not obvious. Therefore, when the motor is decelerated or braked, the assembly error caused vibration can be eliminated.

While we have shown and described various embodiments in accordance with the present invention, it is clear to those skilled in the art that further embodiments may be made without departing from the scope of the present invention.

What is claimed is:

1. A motor structure with a brake device comprising: a base serving as a mounting frame for mounting respective components of the motor, a stator being a hollow annular structure fixed in the base, a rotor being a hollow annular structure rotatably disposed in the base and being located inside the stator and being rotatable relative to the stator, and a brake device serving to decelerate or stop the rotation of the motor and being disposed at a lower end of the base;
the motor structure is characterized in that: a hollow passage surface is formed in a side of the rotor, at a lower end of the hollow passage surface is formed a connecting portion, the brake device is located at the lower end of the base and connected to the connecting portion, so that the brake device is directly connected to the rotor.
